(19) United States
(12) Patent Application Publication
(10) Pub. No.: US 2016/0334913 A1
(43) Pub. Date: Nov. 17, 2016

(54) Touch Sensing Device

(71) Applicant: Zhengmin Banjamin Pan, LA, CA (US)

(72) Inventor: Zhengmin Banjamin Pan, LA, CA (US)

(73) Assignee: AAC TECHNOLOGIES PTE. LTD., Singapore city (SG)

(21) Appl. No.: 14/930,257

(22) Filed: Nov. 2, 2015

(30) Foreign Application Priority Data
May 12, 2015 (CN) 201520303146.3

(51) Int. Cl. G06F 3/041; G06F 3/01

(52) U.S. Cl. CPC G06F 3/0414; G06F 3/016; G06F 3/0416

(57) ABSTRACT

The disclosure provides a touch sensing device including a press interface, a pressure sensing including a flexible connecting piece forming a sealed space, and a pressure transducer having an opening communicated with the seal space. The flexible connecting piece is connected with the press interface for being pressed when the press interface is pressed. The pressure transducer outputs electrical signals according to the change of air pressure inside the sealed space when the press interface is pressed.

### FIELD OF THE INVENTION

The present invention is related to transducer, and more particularly to a touch sensing device applied to a portable electronic device.

### DESCRIPTION OF RELATED ART

With the rapid development of changing science and technology, intelligent portable electronic equipment becomes popular gradually, such as intelligent cell phone, intelligent bracelet, intelligent watch and intelligent computer etc. While pursue the intellectualization of portable electronic equipment, user pays more attention to let portable electronic equipment have colorful user experiences. How to realize user experience of man-machine-unification of portable electronic equipment instead of icy and mechanical input and output operation has become the focus that major manufacturers are researching.

Thus, it is one of the purposes of the present invention to provide a touch sensing device for achieving the object mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an illustration of a touch sensing device in accordance with a first embodiment of the present disclosure.

FIG. 2 is an illustration of a touch sensing device in accordance with a second embodiment of the present disclosure.

FIG. 3 is an illustration of a portable electronic device using the touch sensing device of the present disclosure.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of present disclosure more apparent, the present disclosure is described in further detail together with the figures and the embodiments. It should be understood the specific embodiments described hereby is only to explain this disclosure, not intended to limit this disclosure.

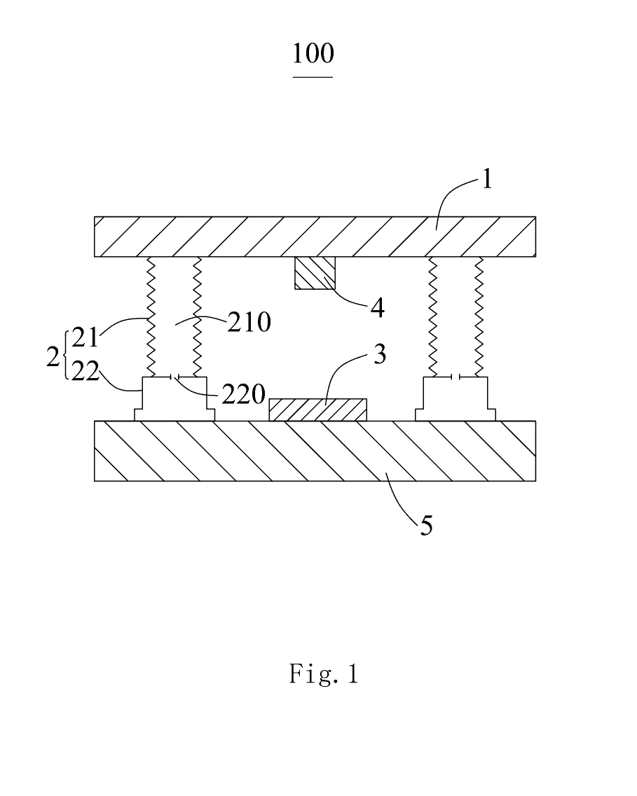

As shown in FIG. 1, a touch sensing device 100 of a first embodiment of the present disclosure includes a press interface 1, a pressure sensing mechanism 2 and a substrate 5. The pressure sensing mechanism 2 includes a flexible connecting piece 21 and a pressure transducer 22. The pressure transducer 22 may be a MEMS pressure transducer. The flexible connecting piece 21 has one end connecting with the press interface 1, and another end connecting with the pressure transducer 22. When the press interface 1 is pressed by a user, the press interface 1 compresses the flexible connecting piece 21. The flexible connecting piece 21 may be a spring or a soft flexible part such as silica gel. The flexible connecting piece 21 forms a sealed space 210. The pressure transducer 22 includes an opening 220 communicating with the sealed space 210. When the press interface 1 is pressed, the gas inside the sealed space 210 is compressed. The air pressure inside sealed space 210 accordingly changes. The pressure transducer 22 outputs electrical signals according to the change of the air pressure inside the sealed space 210. The touch sensing device 100 further includes a processor module 3. The processor module 3 is used to process the electrical signals output by the pressure transducer 22. The pressure transducer 22 and the processor module 3 are installed on the substrate 5. The substrate 5 can be the main board or other parts of a portable electronic device 300 which will be mentioned later.

The touch sensing device 100 further includes an actuator 4. The actuator 4 is installed on the pressure interface 1. When the press interface 1 is pressed by the user, the processor module 3 processes the electrical signals output by pressure transducer 22 to output control signals to the actuator 4 for driving the actuator 4. Accordingly, the actuator 4 drives the press interface 1 to vibrate and provide the user with force feedback. Optionally, the force feedback can be such designed that the greater the press interface 1 is pressed, the stronger force feedback is provided.

The touch sensing device 100 includes program execution management module further (no shown on the figure). Press the press interface 1, the processor module 3 processes the electrical signal output by the pressure transducer 22 to calculate grade according to the pressure. The mentioned program execution management module chooses to execute the corresponding program according to predetermined grade of pressure and the associated information corresponding to the execution of program.

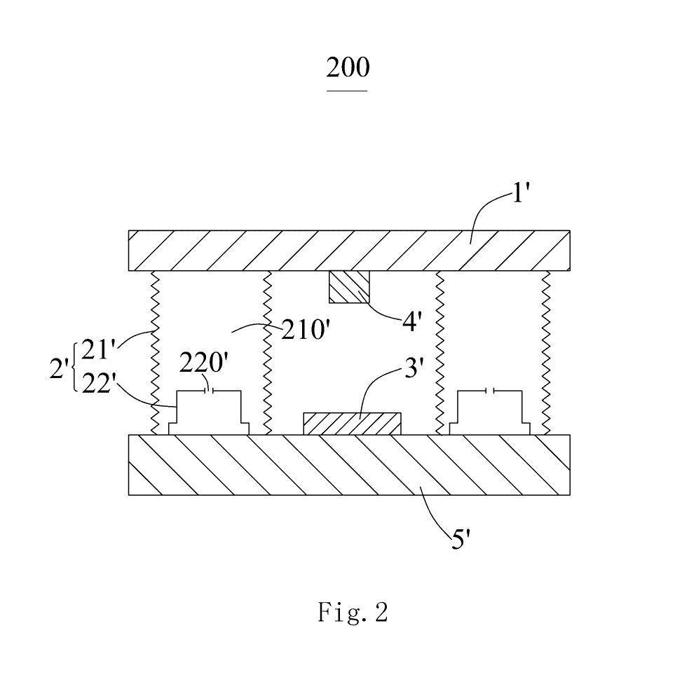

As shown in FIG. 2, the touch sensing device 200 of a second embodiment includes a press interface 1′, a pressure sensing mechanism 2′, a processor module 3′, an actuator 4′, an substrate 5′ and a program execution management module (not shown on figure). The pressure sensing mechanism 2 includes a flexible connecting piece 21′ and a pressure transducer 22′. The flexible connecting piece 21′ forms a sealed space 210′. An opening 220′ is provided in the pressure transducer 22′. The pressure transducer 22′ is communicated with the sealed space 210′ through the opening 220′. The difference of the second embodiment from the touch sensing device 100 of the first embodiment is the configuration of the sealed space 210′. The flexible connecting piece has an end connecting to the press interface and another end connecting to the substrate. The pressure transducer 22′ is located in the sealed space 210′ formed by the flexible connecting piece 21′ directly. In fact, strictly speaking, the sealed space should include the space inside pressure transducer t00.

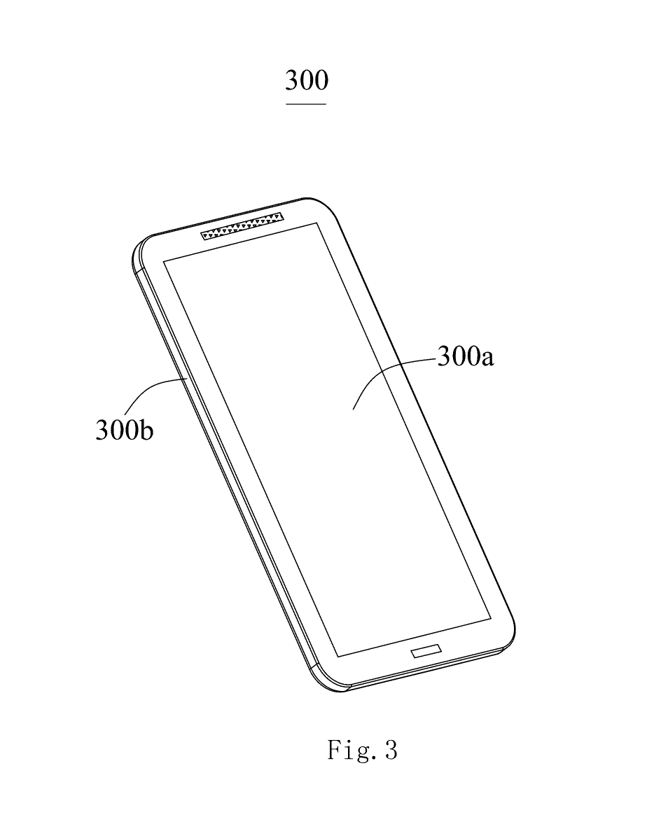

As shown in FIG. 3, a portable electronic device 300 using such a touch sensing device as described above is provided. The portable electronic device 300 may be a cell phone, intelligent bracelet, intelligent watch and tablet PC etc. The portable electronic device 300 includes a screen 300a and/or a side frame 300b. The screen 300a and/or the side frame 300b can be chosen as the press interface of touch sensing device.

The touch sensing device provided by the present disclosure can enhance the touch experience of the user. User can feel the force feedback vibration of press and can control and choose the execution of different programs according to grade of press of user the when user presses the press interface.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A touch sensing device including:
a press interface;
a pressure sensing including a flexible connecting piece forming a sealed space, and a pressure transducer having an opening communicated with the seal space, the flexible connecting piece being connected with the press interface for being pressed when the press interface is pressed; wherein
the pressure transducer outputs electrical signals according to the change of air pressure inside the sealed space when the press interface is pressed.

2. The touch sensing device as described in claim 1, further including an actuator assembled with the touch interface for driving the press interface.

3. The touch sensing device as described in claim 2 further including a processor module for handling the electrical signals from the pressure transducer, and for outputting control signals to the actuator for performing force feedback, the control signals being corresponding to the electrical signals from the pressure transducer.

4. The touch sensing device as described in claim 3, wherein the greater the pressure of pressing the press interface is, the stronger the force feedback is.

5. The touch sensing device as described in claim 1 further including a program execution management module for choosing corresponding program according to preset grade of press and the associated information corresponding to execution of program.

6. The touch sensing device as described in claim 1, wherein the pressure transducer is a MEMS pressure transducer.

7. A portable electronic device comprising a touch sensing device as described in claim 1.

8. The portable electronic device as described in claim 7 including a screen serving as the press interface.

9. The portable electronic device as described in claim 7 including a side frame serving as the press interface.
